(19) United States
(12) Patent Application Publication
(10) Pub. No.: US 2007/0247359 A1
(43) Pub. Date: Oct. 25, 2007

(54) Automatic GPS tracking system with passive battery circuitry

(76) Inventor: Ohanes D. Ghazarian, Henderson, NV (US)

Correspondence Address: OHANES D. GHAZARIAN, 2575 W. HORIZON RIDGE PKWY #1611, HENDERSON, NV, 89052, US

(21) Appl. No.: 11/411,164

(22) Filed: Apr. 25, 2006

(51) Int. Cl. G01S 5/14; G08B 1/08; G08B 23/00; H04B 1/16; H04Q 7/00

(52) U.S. Cl. 342/357.07; 340/539.13; 340/693.3; 455/343.2

(57) ABSTRACT

Portable Battery operated asset mount GPS tracking apparatus, having a processor, GPS receiver and a satellite or cellular modem. Incorporated with a low power consumption RF transceiver, the transceiver is designed to communicate at time interval with a home base station RF transceiver unit, located within the communication range of the GPS tracking unit. When the GPS unit is present within communication range of home base unit, the GPS unit's receiver, satellite or cellular modem power circuitry is in “Off” position. If and when a subject or asset carrying GPS unit, moves out of communication range from home base unit, the GPS unit transceiver circuitry within a predetermined time detects RF communication signal loss, and “Power's On” GPS tracking unit receiver and satellite or cellular modem circuitry. The method provides user automatic asset movement tracking, and conserves GPS unit battery consumption, and provides longer period of portable GPS unit operation.

### BACKGROUND OF INVENTION

The present invention relates to the tracking of individuals or assets providing knowledge of their location. More specifically, present invention relates to tracking GPS tags having battery as power supply, which is warn/installed on subjects, or assets. When the subject or asset to be monitored moves away from a dedicated area, the method provides automatic GPS monitored and a GPS unit that does not require often battery charging or replacement.

When subject or asset to be monitored leave a dedicated area, the GPS unit transceiver circuitry within predetermined time detects RF signal loss and switch ON GPS tracking circuitry power to ON position, only when said GPS unit moves away from a home base unit designated area. Such as a house, school, prison, camp, vehicle, warehouse, aircraft etc.

In the passed many different methods has being used for electronic monitoring of individuals in open field, such as offenders, personnel, assets etc. primarily is accomplished by use of warn or carry on GPS tags, having a processor, a global positioning satellite receiver, a wireless modem for two way communication with a monitoring station, powered by a battery. Used for tracking offenders, personnel, or other assets based on restraint or allow-ability for user to enter or exit a dedicated area. The system includes GPS receiver/transmitter for receiving GPS timing signals, a processor/comparator for calculating and storing a waypoint. The mapping algorithm calculates mapped programmed confinement area from a waypoint obtained, along with the perimeter of the physical confinement area, and the comparator provides an output comparing the present position of the GPS receiver/transmitter with the programmed confinement area. The comparator output is transmitted by the receiver/transmitter to a monitoring station PC.

Such prior arts teachings are found in U.S. Pat. No. 6,232,916 to Grillo, et al. U.S. Pat. No. 6,774,797 to Freathy, et al. which illustrates useful methods into tracking of personnel, assets, in particular designated areas where person or asset to be monitored is restrained from entering or exiting a defined zone. In order to obtain such functionality, the GPS units used in prior arts must be powered ON all the time wile in use, which require comparator, the wireless modem to receive and transmit signal, will require often battery charging or replacement.

One can imagine, if Grillo et al, or Freathy et al. teaching method was used on thousands of GPS units to track assets, animals Etc. It will take large amount of crew just to service each GPS tracking unit battery every day or two, or may be maximum a week, using large capacity (size and weight) battery on a person or animal, which makes the use of the art unpractical.

Further, a more useful method found in prior art teaching as illustrated in U.S. Pat. No. 6,104,979 to Harrison, which teaches a communication method for both the asset energy requirement and communication channel occupancy in a reduce order GPS asset tracking system. The asset is provided with an indication of its position so as to allow detection of movement of the asset. Reduced order GPS data driven at the asset, for shorter data transmission times. This capability can be used to save energy, for example, reporting to the central station less frequently when the asset position is unchanged.

As Harrison teaches a centralize tracking with reduce energy consumption, never less if such teaching was to be implemented in applications where an asset or a person to be monitored was in an unchanged position within a dedicated area, the art still requires battery energy in order to operate GPS tracking device, other then reporting to central station less frequently.

It is accordingly primary objective of the present invention which utilizes a Portable Battery operated asset mount GPS tracking apparatus, having a processor, GPS receiver and a satellite or cellular modem. Incorporated with a low power consumption RF transceiver, designed to communicate at time interval with a home base station RF transceiver unit, located within the communication range of the GPS tracking unit. When the asset carrying GPS unit, moves out of communication range from home base unit, the GPS unit transceiver circuitry at predetermined time detects RF communication signal loss, and “Power's On” GPS tracking unit receiver and satellite or cellular modem circuitry. The method provides user automatic asset movement tracking, and powers ON the GPS unit receiver and modem circuitry only when the GPS unit is away from home base unit. The present art teaching is designed to conserves GPS unit battery power, and providing spared battery power when needed thus providing longer period portable GPS unit operation.

Never less prior art teaching found in U.S. Pat. No. 6,232,916 to Grillo et al. U.S. Pat. No. 6,774,797 to Freathy et al, and U.S. Pat. No. 6,104,978 as well as the other GPS tracking systems mentioned are important and useful background to the present invention, her each are incorporated herein by reference.

### SUMMARY OF THE INVENTION

The present invention provides a portable Battery operated asset mount GPS tracking apparatus, having a processor, GPS receiver and a satellite or cellular modem. Incorporated with a low power consumption RF transceiver, using a battery as power supply, designed to communicate at time interval with a home base station RF transceiver unit, located within the communication range of the GPS tracking unit.

The GPS tracking has a dedicated rechargeable battery to provide power to the GPS receiver and wireless modem circuitry. When the GPS unit is present within communication range of home base unit, the GPS unit's receiver, satellite or cellular modem power circuitry is in “Off” position.

If and when the asset carrying GPS unit, moves out of communication range from home base unit, the GPS unit's RF transceiver circuitry at predetermined time detects RF communication signal loss, and “Power's On” GPS tracking unit receiver and satellite or cellular modem Battery circuitry. The method provides user automatic asset movement tracking, conserves GPS unit battery to be available only when GPS becomes in use, thus providing longer period of portable GPS unit operation.

### BRIEF DESCRIPTION OF THE DRAWINGS

This and other advantages of the present invention are best understood with reference to the drawings, in which;

FIG. 1 Is drawn with view of a wearable GPS tracking devise having a temper detection strap, a low power consumption RF transceiver, GPS receiver circuitry, GSM or satellite modem, and a single or dual battery compartment, one for providing power to RF transceiver, and the other providing power to GPS and wireless modem data communicator circuitry.

FIG. 2 Is a drawing view of a asset mount GPS tracking devise, a low power consumption RF transceiver, GPS receiver circuitry, GSM or satellite modem, and a single or dual battery compartment, one providing power to RF transceiver, and the other providing power to GPS and wireless modem data communication circuitry.

FIG. 3 Is a drawing view of asset mount GPS unit optical temper detection circuitry.

FIG. 4 Is a drawing personnel and asset carrying GPS tracking device, A house equipped with a home base RF transceiver unit, and a monitoring station.

FIG. 5 Is the Block Diagram of the art.

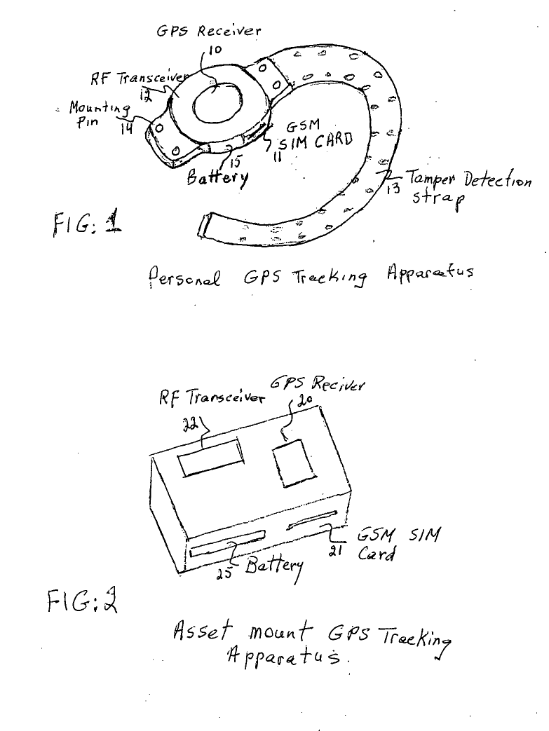

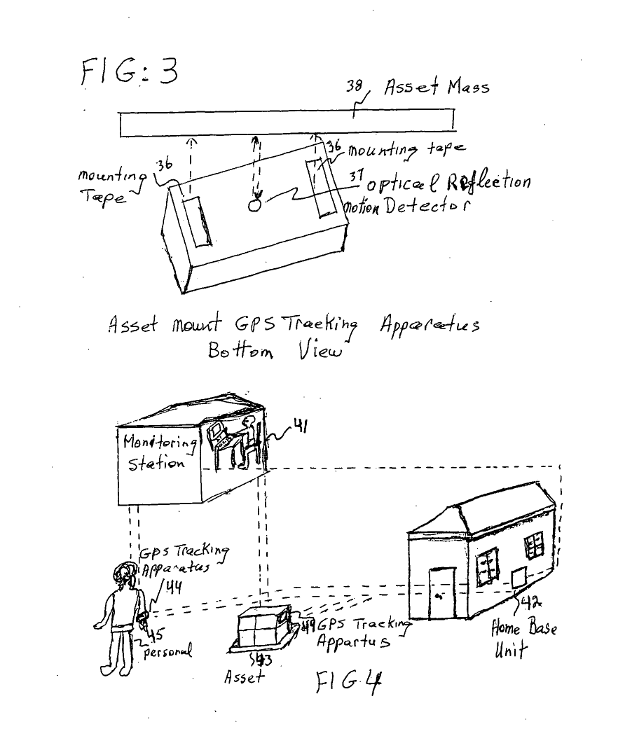

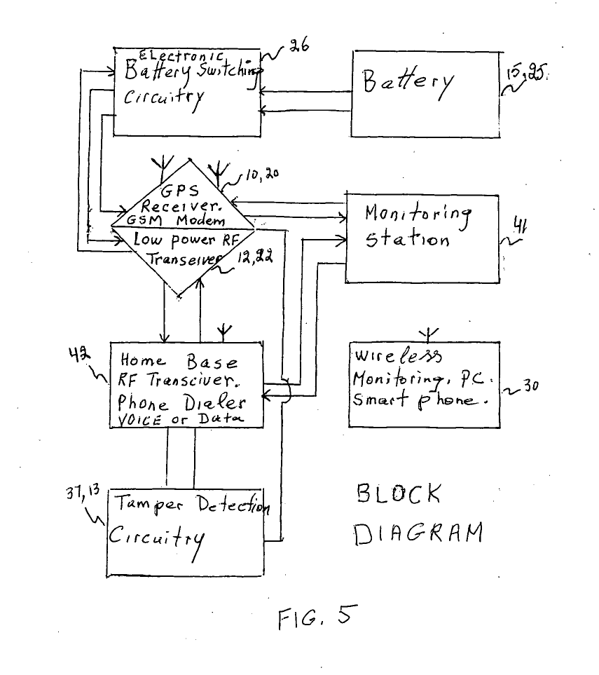

### DETAILED DESCRIPTION OF A PREFERRED EMBODIMENT OF THE INVENTION

The present invention provides a portable Battery 15, 25 operated asset 43 or personnel 45 mount GPS tracking apparatus 44, 49, having a processor, GPS receiver 10, 20 and a satellite or cellular modem 11, 21. Incorporated with a low power consumption RF transceiver 12, 22, using a battery 15, 25 or dual battery, one to provide power to low power RF transceiver circuitry 12, 22 and a preferably a rechargeable Li Ion battery to provide power to GPS receiver 10, 20, and wireless communication modem 11, 21. The low power consumption RF transceiver 12, 22 is designed to communicate at time interval with a home base station RF transceiver unit 42, located within the communication range of the GPS tracking unit.

The GPS tracking unit 44, 49 of the present invention has a dedicated rechargeable battery 15, 25 to provide power to the GPS receiver 10, 20 and wireless modem circuitry 11,21. When the GPS unit 44, 49 is present within communication range of home base unit 42, the GPS unit's receiver 10, 20, satellite or cellular modem 11, 21 power circuitry 26 is in “Off” position.

If and when the asset 43 or personnel 45 carrying GPS unit 44, 49, moves out of communication range from home base unit 42, the GPS unit's RF transceiver circuitry 12, 22 at predetermined time detects RF communication signal loss, and “Power's On” GPS tracking unit 44, 49 receiver 10, 20 and satellite or cellular modem 11, 21 Battery circuitry 26. The method provides user automatic asset movement tracking, conserves GPS unit battery 15,25 and make stored power be available only when GPS tracking circuitry 10, 11, 20, 21 becomes in use, thus providing longer period of portable GPS unit operation.

To provide secure personnel 45 or asset 43 tracking the GPS tracking system of the present invention utilizes GPS tracking unit 44, 49 with temper detection 37,13 method designed for securing the GPS unit on subject 45 to be monitored by use of a tamper detection strap 13 and pins 14, or an asset mount GPS device 49 having on bottom side velcro tape 36 for mounting the GPS unit 49 on assets 43 which utilizes optical reflection motion sensor 37 to detect unauthorized removal of GPS tracking unit 49.

To provide mobile tracking ability to a monitoring station. A wireless monitoring PC, Smart phone is 30 could be utilized for tracking personnel 45 and assets 43 via a wireless network.

1. A portable Battery operated asset or personnel mount GPS tracking apparatus, having a processor, GPS receiver and a satellite or cellular modem. Incorporated with a low power consumption RF transceiver, and a GPS unit power switching circuitry. Said RF transceiver is designed to communicate at time interval with a home base station RF transceiver unit, located within the communication range of said GPS tracking unit. If and when said GPS unit located within communication range of said home base unit, said GPS unit receiver, satellite or cellular modem power circuitry is in “Off” position. If and when a subject or asset carrying said GPS unit, moves away from said home base unit, said GPS unit transceiver circuitry at predetermined time detects RF communication signal loss, and “Power's On” said GPS tracking unit receiver and satellite or cellular modem circuitry. Which provides user automatic asset or personnel movement tracking, and conserves GPS unit battery consumption, allowing said conserved battery power be used only when said GPS unit moves away from a dedicated area, and provide longer period of portable GPS unit operation without the need of user frequent battery charging.

2. A portable tracking apparatus as claimed in claim 1, wherein said GPS tracking unit preferable utilizing two sets of batteries. Said first battery is designed to provide power to said RF transceiver unit to communicate at time interval with said home base unit, and said second battery is designed to provide stand by battery power to said GPS unit receiver, and or wireless modem to communicate with a monitoring station.

3. A portable tracking apparatus as claimed in claim 2, wherein said GPS tracking unit 1 first and or second batteries is rechargeable.

4. A portable tracking apparatus as claimed in claim 1, wherein said GPS tracking apparatus is installed on an asset or personnel, utilizing an optical motion sensor to detect said GPS unit removal tamper.
